(19) United States
(12) Patent Application Publication
(10) Pub. No.: US 2014/0209199 A1
(43) Pub. Date: Jul. 31, 2014

(54) PIPE SEALING DEVICE

(71) Applicant: Man-Chi Chang, Taichung (TW)

(72) Inventor: Man-Chi Chang, Taichung (TW)

(21) Appl. No.: 13/749,704

(22) Filed: Jan. 25, 2013

(51) Int. Cl. F16L 55/11

(52) U.S. Cl. CPC F16L 55/1108
USPC 138/89

(57) ABSTRACT

A pipe sealing device includes a body, multiple mounting members and a sealing member. The body has a space and a first connection portion. Two first contact portions extend from the first end of the body and each mounting member has two second contact portions which contact the first contact portions. The mounting members are located in the space and each has a recess with which a pipe is engaged. The pipe has an opening which contacts the end faces of the recess. The sealing member has a second connection portion which is connected to the first connection portion of the body. The second connection portion has a sealing face which seals the opening of the pipe.

### FIELD OF THE INVENTION

The present invention relates to a sealing device, and more particularly, to a pipe sealing device to prevent liquid in the pipe from flowing out from the pipe.

### BACKGROUND OF THE INVENTION

The conventional pipe sealing device is disclosed in FIG. 14 and generally comprises a body 81 having a slot 811 defined in the first end thereof and a first threading portion 812 is defined in the second end of the body 81. A pipe 82 is engaged with the slot 811 of the body 81 and includes an opening 821. The pipe 82 can be a pipe removed from a vehicle so that liquid may be left in the pipe 82. A sealing member 83 has a second threading portion 831 which is threadedly connected to the first threading portion 812 of the body 81. The sealing member 83 has a sealing face 832 on one end thereof and the sealing face 832 seals the opening 821 of the pipe 82 to prevent the liquid from flowing out from the pipe 82.

As shown in FIGS. 15 and 16, the pipe 82 may have different diameters which start from 4.2 mm to 10 mm, there are three bodies 81 of different sizes needed. The three bodies 81 have three slots 811 of different sizes so as to be cooperated with the pipes 82. The users have to prepare multiple bodies of different sizes.

The present invention intends to provide a pipe sealing device cooperated with different sizes of mounting members so as to seal the pipes of different sizes.

### SUMMARY OF THE INVENTION

The present invention relates to a pipe sealing device and comprises a body, multiple mounting members and a sealing member. The body has a space and a first connection portion respectively on two ends thereof. Two first contact portions extend from the first end of the body and the mounting members each have two second contact portions which contact the first contact portions. The mounting members are located in the space and each has a recess with which a pipe is engaged. The pipe has an opening which contacts the end faces of the recess. The sealing member has a second connection portion which is connected to the first connection portion of the body. The second connection portion has a sealing face which seals the opening of the pipe.

The recesses of the multiple mounting members have different sizes so as to engage with the pipes of different sizes. The present invention can seal different pipes by the multiple mounting members and this saves the users' expenses.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pipe sealing device of the present invention;

FIG. 2 is a perspective view to show the pipe sealing device of the present invention;

FIG. 3 is a side view to show the pipe sealing device of the present invention;

FIG. 4 is a cross sectional view, taken along line A-A of FIG. 3;

FIG. 5 is a cross sectional view to show that the pipe is connected with the mounting member while the sealing member does not yet seal the pipe;

FIG. 6 is a perspective view to show the multiple mounting members of the present invention;

FIG. 7 shows the mounting member, the first seal and the second seal of the present invention;

FIG. 8 shows another pipe is sealed by the pipe sealing device of the present invention;

FIG. 9 is a cross sectional view to show that the pipe in FIG. 8 is sealed by the pipe sealing device of the present invention;

FIG. 10 is an exploded view of the second embodiment of the pipe sealing device of the present invention;

FIG. 11 is a perspective view to show the second embodiment of the pipe sealing device of the present invention;

FIG. 12 is a side view to show the second embodiment of the pipe sealing device of the present invention;

FIG. 13 is a cross sectional view, taken along line A-A of FIG. 12;

FIG. 14 is an exploded view of the conventional pipe sealing device;

FIG. 15 is a perspective view to show the conventional pipe sealing device, and

FIG. 16 shows the conventional mounting member.

### DETAILED DESCRIPTION OF THE PREFERRED EMBODIMENT

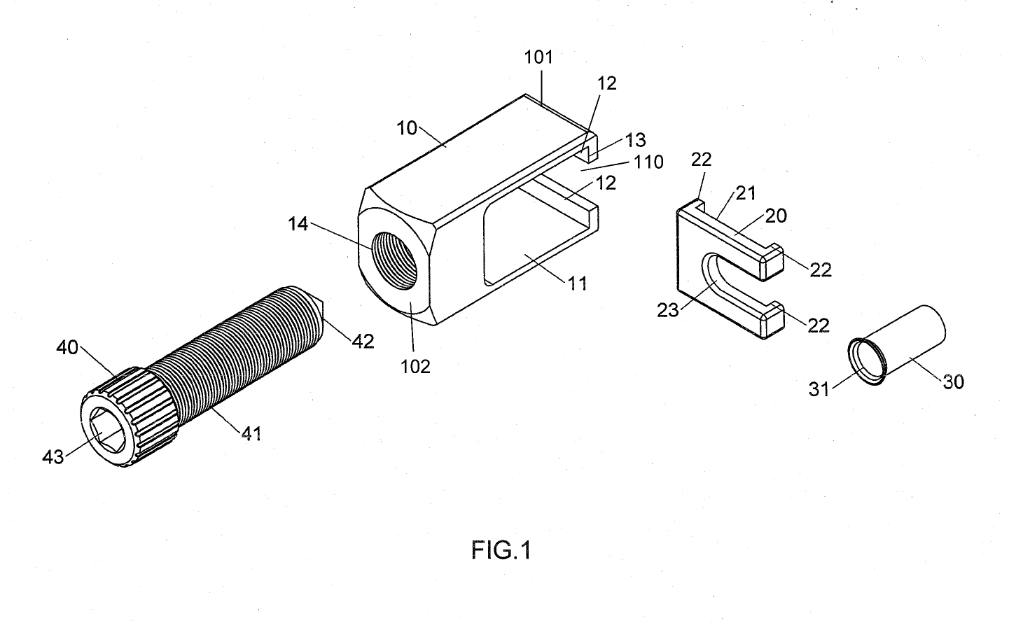

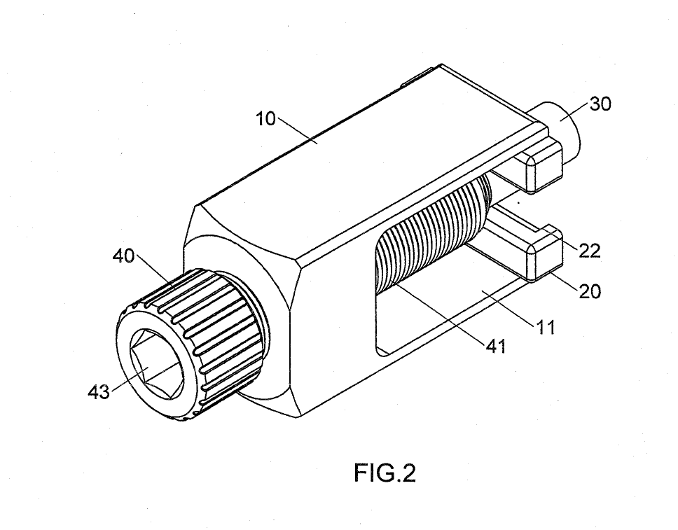

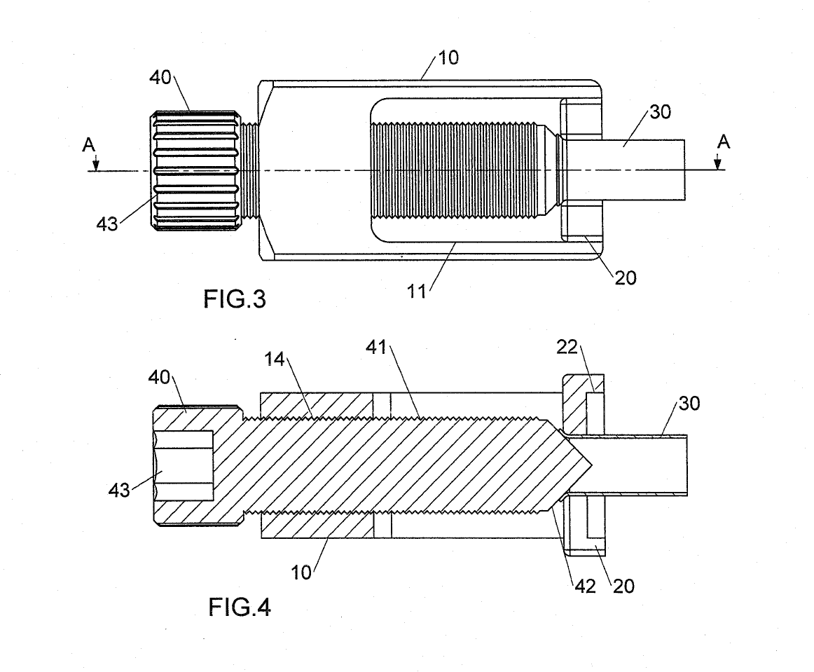

Referring to FIGS. 1 to 4, the pipe sealing device of the present invention comprises a body 10 having a space 11 defined in the first end 101 thereof, and the space 11 transversely opens through the body 10 and connects an opening 110 provided at the first end 101 of the body 10. Two opposite first contact portions 12 extend from the opening 110 of the first end 101 of the body 10 and face to each other. Each first contact portion 12 has two first sides 13 on two ends thereof. A first connection portion 14 is defined in the second end 102 of the body 10. The first connection portion 14 is a threaded hole.

Multiple mounting members 20 are non-movably located in the space 11 and each mounting member 20 has two second contact portions 21 and each second contact portion 21 has two second sides 22 extending from two sides thereof. The second contact portions 21 contacts the first contact portions 12. The second sides 22 contact the fist sides 13. Each mounting member 20 has a U-shaped recess 23 which opens laterally.

A pipe 30 is engaged with the recesses 23 of the mounting members 20, and the pipe 30 has an opening 31 which contacts the end face of the recess 23. The pipe 30 is removed from piping systems or vehicles, such as the gas pipe, so that liquid may be left in the pipe 30.

A sealing member 40 has a second connection portion 41 which has outer threads and is threadedly connected to the first connection portion 14. The sealing member 40 is movable relative to the body 10. The second connection portion 41 has a sealing face 42 defined in the first end thereof and the sealing face 42 seals the opening 31 of the pipe 30. The sealing face 42 is a cone-shaped face so as to be engaged with the opening 31 so as to prevent the liquid in the pipe 30 from flowing out from the pipe 30. The sealing member 40 has a driving portion 43 defined in the second end thereof, the driving portion 43 is a hexagonal recess or other shaped recess with which a tool can be engaged to rotate the sealing member 40.

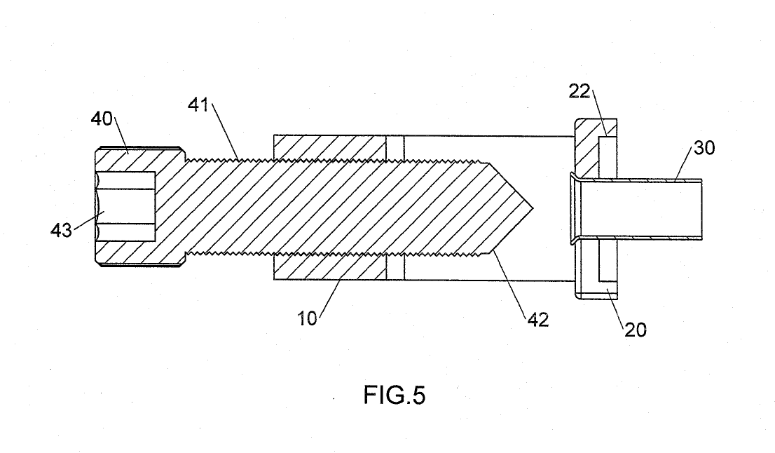

As shown in FIG. 5, the sealing member 40 is rotated to remove the sealing face 42 from the opening 31 of the pipe 30. The pipe 30 is then removed and connected to another pipe to form a loop.

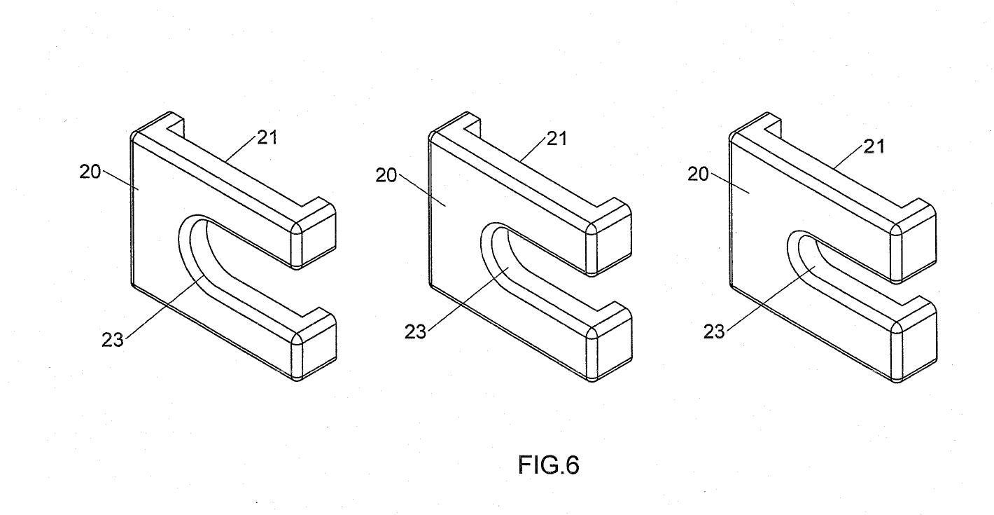

As shown in FIG. 6, the recesses 23 of the mounting members 20 have different sizes so that different pipes 30 can be engaged with the recesses 23. The body 10 accommodates the multiple mounting members 20 so as to save the expenses of the users.

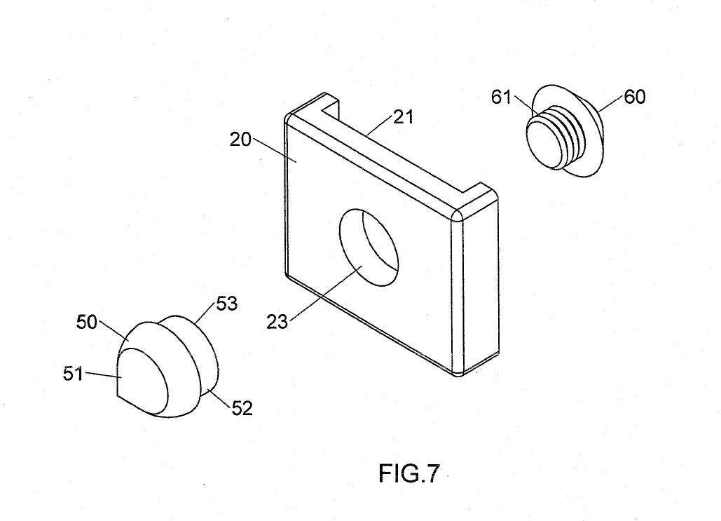

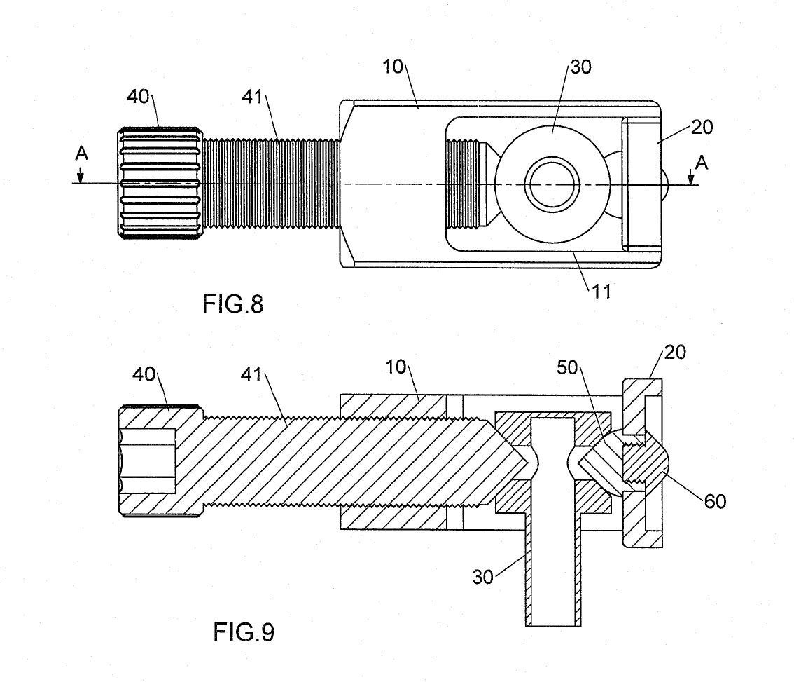

As shown in FIG. 7, the embodiment of the recess 23 of the mounting member 20 is a hole and a first seal 50 is engaged with the hole. The first seal 50 has a cone-shaped face 51 on the first end thereof and an insertion portion 52 extends from the second end of the first seal 50. The insertion portion 52 is engaged with the recess 23 of the mounting member 20 and the cone-shaped face 51 extends from the mounting member 20. The cone-shaped face 51 has the identical structure of the sealing face 42 of the sealing member 40 so as to seal the opening 31 of the pipe 30. The insertion portion 52 has a third connection portion 53 which is a threaded hole. A second seal 60 has a fourth connection portion 61 which is a threaded portion and threadedly connected to the third connection portion 53 to secure the first seal 50 to the mounting member 20. As shown in FIGS. 8 and 9, the pipe 30 has two openings 31, one of the two openings 31 is sealed by the sealing face 42 and the other opening 31 is sealed by the cone-shaped face 51.

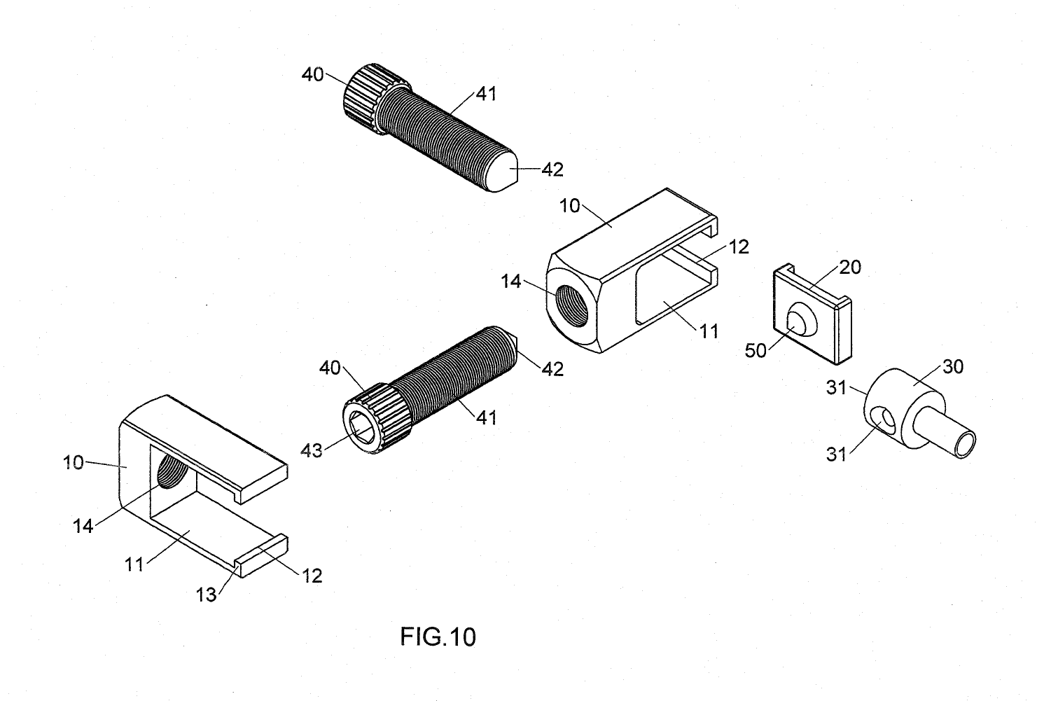

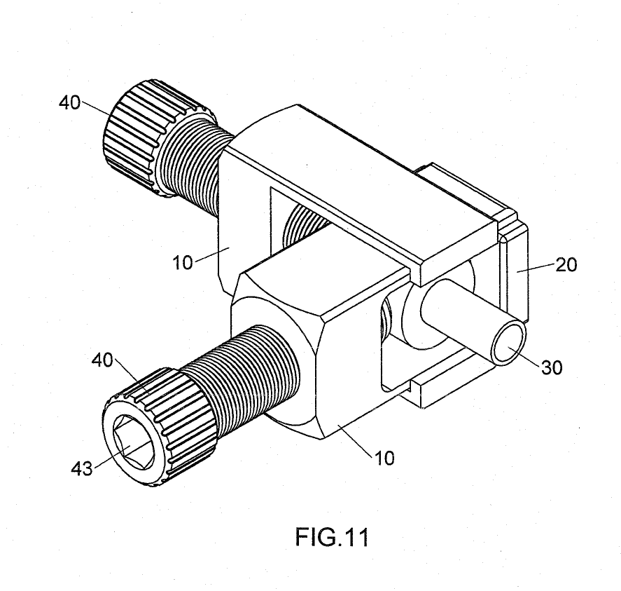

As shown in FIG. 10 showing the second embodiment of the present invention which comprises a second body 10 and a second sealing member 40. The second body 10 is identical to the first body 10 except for the width of the space 11 of the second body 10 is the same as the thickness of the first body 10. The first body 10 is located in the space 11 of the second body 10. The first contact portions 12 of the second body 10 are in contact with one side of the first body 10. The second sealing member 40 is identical to the first sealing member 40.

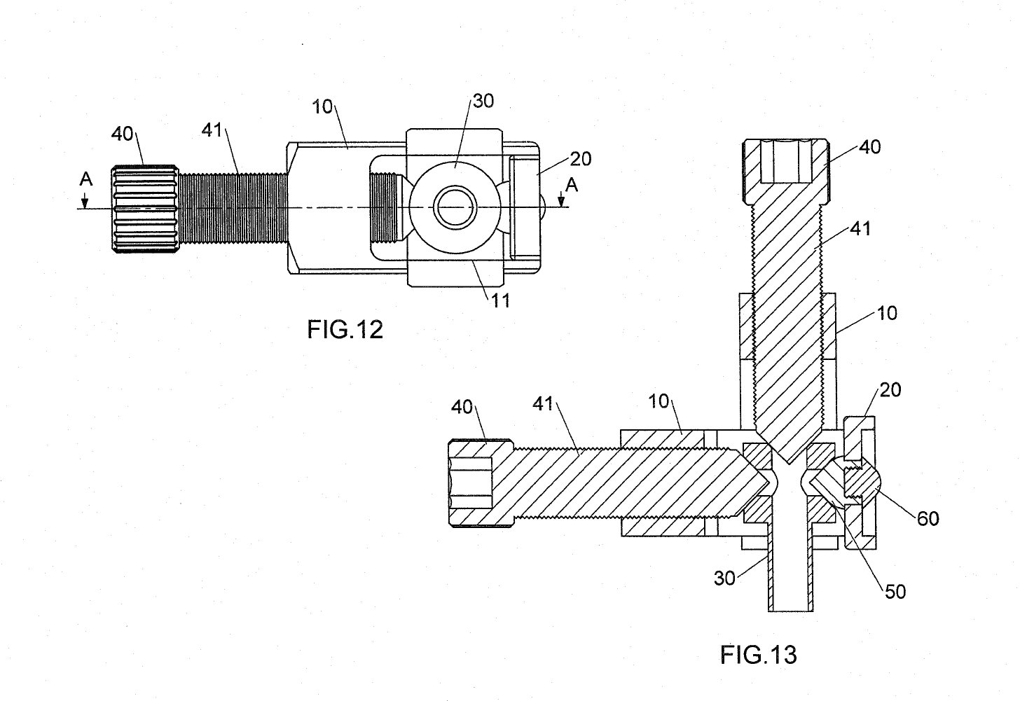

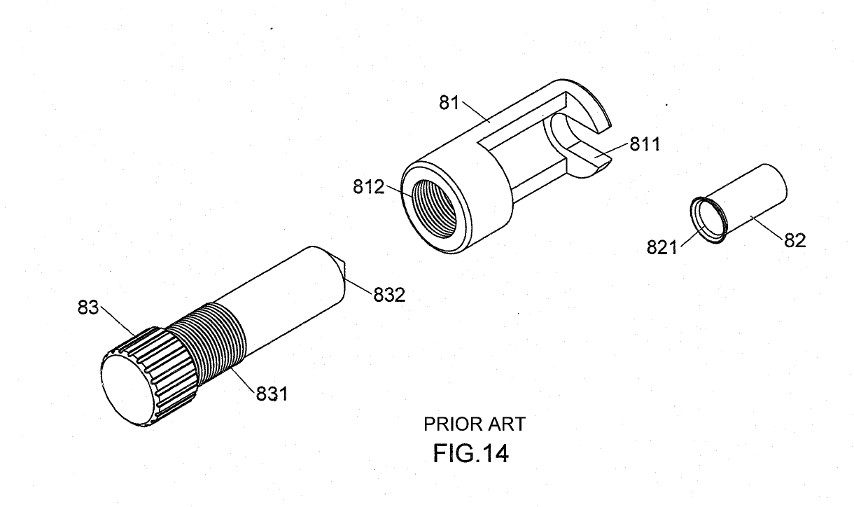

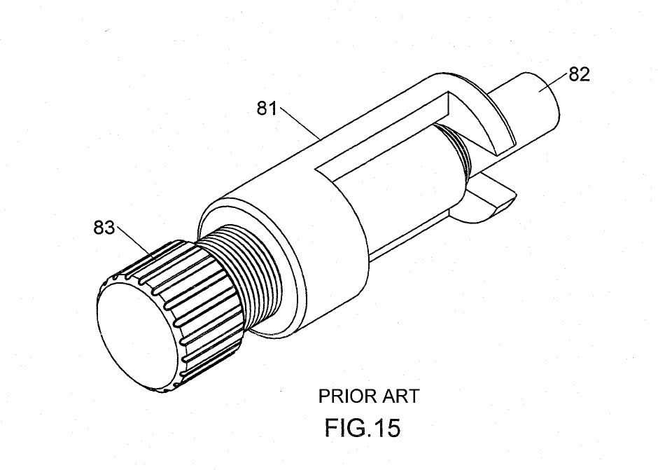

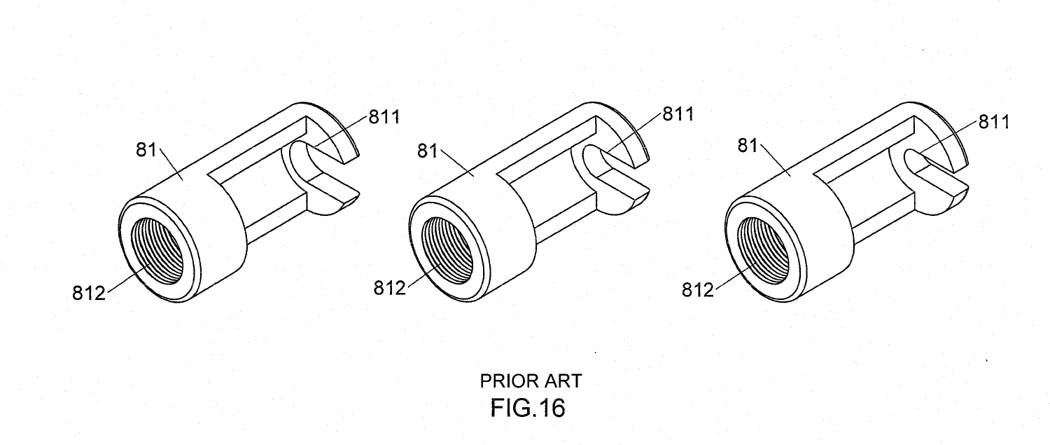

As shown in FIGS. 12 and 13, some of the pipes 30 have three openings 31, wherein the first one of the openings 31 is sealed by the first sealing member 40, the second one of the openings 31 is sealed by the first seal 50, and the third one of the openings 31 is sealed by the second sealing member 40.

When there are two openings 31 in one pipe 30 and the two openings 31 are perpendicular to each other, the first one of the openings 31 is sealed by the first sealing member 40, and the second one of the openings 31 is sealed by the second sealing member 40. In another embodiment, a resilient member is mounted to the sealing face 42 of the sealing member 40 and the resilient member seals the opening 31 of the pipe 30. The cone-shaped face 51 of the first seal 50 has a resilient member mounted thereto.

There are multiple mounting members 20 available in the body 10 of the present invention, and the multiple mounting members 20 have different sizes of recesses 23 so as to be cooperated with the pipes 30 of different sizes. The multiple mounting members 20 save the expenses of the users.

While we have shown and described the embodiment in accordance with the present invention, it should be clear to those skilled in the art that further embodiments may be made without departing from the scope of the present invention.

What is claimed is:

1. A pipe sealing device comprising:
a body having a space defined in a first end thereof, the space transversely opening through the body and connecting an opening provided at the first end of the body, two opposite first contact portions extending from the opening of the first end of the body and facing to each other, each first contact portion having two first sides on two ends thereof, a first connection portion defined in a second end of the body 10, the first connection portion being a threaded hole;
multiple mounting members each having two second contact portions and each second contact portion having two second sides extending from two sides thereof, the second contact portions contacting the first contact portions, the second sides contacting the fist contacts, each mounting member being non-movably located in the space, each mounting member having a U-shaped recess;
a pipe engaged with the recesses of the mounting members, the pipe having an opening which contacts an end face of the recess, and
a sealing member having a second connection portion which has outer threads and is threadedly connected to the first connection portion, the sealing member being movable relative to the body, the second connection portion having a sealing face defined in a first end thereof and the sealing face sealing the opening of the pipe, the sealing face being a cone-shaped face so as to be engaged with the opening.

2. The pipe sealing device as claimed in claim 1, wherein the sealing member has a driving portion defined in a second end thereof, the driving portion is a hexagonal recess.

3. The pipe sealing device as claimed in claim 1 further comprising a first seal which has a cone-shaped face on a first end thereof and an insertion portion extending from a second end of the first seal, the insertion portion engaged with the recess of the mounting member and the cone-shaped face extending from the mounting member, the cone-shaped face sealing the opening of the pipe, the insertion portion having a third connection portion which is a threaded hole, a second seal having a fourth connection portion which is a threaded portion and threadedly connected to the third connection portion to secure the first seal to the mounting member, the pipe having two openings, one of the two openings being sealed by the sealing face and the other opening being sealed by the cone-shaped face.

4. The pipe sealing device as claimed in claim 1 further comprising a second body and a second sealing member, the second body being identical to the first body except for a width of the space of the second body being the same as a thickness of the first body, the first body located in a space of the second body, first contact portions of the second body being in contact with a side of the first body, the second sealing member being identical to the first sealing member.

5. The pipe sealing device as claimed in claim 1, wherein a resilient member is mounted to the sealing face of the sealing member and seals the opening of the pipe.
